(19) United States
(12) Patent Application Publication
(10) Pub. No.: US 2006/0205481 A1
(43) Pub. Date: Sep. 14, 2006

(54) FUNDS CONTROLLER FOR GAMING OR ENTERTAINMENT

(75) Inventor: Giovanni DOMINELLI, Toronto (CA)

Correspondence Address: TORYS LLP, 79 WELLINGTON ST. WEST, SUITE 3000, TORONTO, ON, M5K 1N2, CA

(73) Assignee: NRT TECHNOLOGY CORPORATION, Toronto (CA)

(21) Appl. No.: 10/908,453

(22) Filed: May 12, 2005

Related U.S. Application Data
(60) Provisional application No. 60/659,105, filed on Mar. 8, 2005.

(51) Int. Cl. G06F 19/00; G06F 17/00

(52) U.S. Cl. 463/25

(57) ABSTRACT

Apparatus (100), systems (300), and methods for accessing and controlling funds held in electronic accounts (101) for use in gaming and other entertainment purposes, and for processing funds removed from or depositable to such accounts. Funds may be held and processed in cash, electronic, or cash-surrogate form, including the form of vouchers, coupons, tickets, checks, or receipts, for use in gaming, theatrical, or other entertainment.

### CROSS REFERENCE TO RELATED APPLICATION AND INCORPORATION BY REFERENCE

This application claims the benefit of U.S. provisional patent application Ser. No. 60/659,105, filed 8 Mar. 2005 and entitled Funds Controller for Gaming or Entertainment, the entire contents of which are incorporated herein by this reference.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The invention relates to apparatus for accessing and controlling funds. In particular, the invention relates to accessing and controlling funds held in electronic accounts and used for gaming and other entertainment purposes.

### SUMMARY OF THE INVENTION

The invention provides apparatus, systems, methods, and programming for accessing and controlling funds held in electronic accounts for use in gaming and other entertainment purposes, and for processing funds removed from or depositable to such accounts. The invention provides, for example, apparatus, systems, methods, and software for accessing funds held in electronic accounts, and for disbursing such funds in cash, electronic, or cash-surrogate form, such as for example in the form of vouchers, coupons, tickets, checks, or receipts, for use in gaming, theatrical, or other entertainment purposes, as for example on the premises of or otherwise in association with gaming places or other places of entertainment, such as theatres, attractions, and sporting facilities. The invention further provides apparatus, systems, and methods for changing currencies from one form to another, as for example in breaking larger-denomination bills or coins into smaller-denomination money, and/or for exchanging money of one currency for money of another currency (i.e., foreign exchange), and for depositing funds used in or received from gaming and other pursuits.

In one embodiment the invention provides apparatus for processing funds used in or for use in entertainment, such as gaming in a gaming place. The apparatus comprises at least one input device, one or more processors, at least one disburser, and at least one of a voucher issuing device, a coupon issuing device, a reader for interpreting information encoded on a voucher, and a reader for interpreting information encoded on a coupon.

The input device is adapted for acquiring data useful in identifying a monetary fund maintained outside the control of the place of entertainment, and can include any device(s) suitable for that purpose. Input devices suitable for use in implementing the invention include, for example, magnetic readers for reading magnetically-encoded strips on bank cards, devices for reading other electromagnetic tokens, scanners, alphanumeric or special-purpose keys and/or keypads, and/or touch screens.

Monetary funds accessed and processed according to the invention comprise accounts and other funds maintained outside the control of the gaming place or other place of entertainment and can include, for example, bank and/or credit accounts maintained by financial institutions, as opposed for example to funds maintained in in-house accounts by a gaming place such as a casino or arcade.

The processor(s) are adapted for controlling functions related to identifying and accessing funds, and to processing transferred funds, as for example in withdrawals, deposits, and disbursements. The processor(s) may also be adapted for performing other control and/or data processing functions useful, for example, in controlling change-making or other functions performed by systems and apparatus according to the invention. Withdrawals and deposits may be made electronically, for example, from and to accounts maintained by banks and financial institutions outside the control of a gaming place or other place entertainment where the apparatus are to be installed, or for which coupons, vouchers, tickets, etc., are to be disbursed by the apparatus; to electronic house or other accounts maintained by the gaming place or place of entertainment; and may be made electronically or in the form of cash, vouchers, coupons, tickets, or other evidences of value.

The disburser(s) are adapted for disbursing funds received electronically from the monetary fund. Disburser(s) according to the invention may be adapted for disbursing funds in various forms, for example, for dispensing funds received electronically from a monetary fund to a gaming account maintained electronically within the control of a gaming place or other place of entertainment, or in the form of cash, vouchers, coupons, tickets, or other evidence of value. The disburser(s) may also be adapted for other functions, such as foreign currency exchange and change-making. Disbursers suitable for use in implementing the invention may also comprise bill readers or validators.

Functions provided by the input device(s), processor(s), and disburser(s) in accordance with the invention can be performed by any suitable devices. It is contemplated, for example, that in some embodiments these and other functions may be fulfilled through the employment of an automatic teller or automatic banking machine (ATM or ABM), or components thereof, modified or adapted to perform additional functions as described herein, as for example by the addition of components not generally found on such machines.

As will be understood by those familiar with the art, vouchers are objects such as paper or other cards comprising printed indicia or otherwise encoded values representing monetary or other values that may be used in participating in games or other activities. Vouchers are commonly distributed, for example, by gaming entities such as casinos or arcades for use in participating in games within the casino or arcade.

Coupons are objects such as paper or other cards comprising printed indicia or otherwise-encoded values representing monetary or other values that may be redeemed in exchange for goods or services, generally other than gaming participation. For example, it is common practice in casinos, arcades, and other places of entertainment to issue coupons for food, rooms, or other concessions.

Coupons and/or vouchers can also include other evidence of value, including, for example, tickets to theatres or other performances, or for admission to places of interest, such as museums, exhibitions, and sporting places or activities such as ski slopes.

Coupons, vouchers, and other evidences of value according to the invention may be provided on paper, plastic, or other cards, or in other forms, and encoded with printed indicia, magnetic coding embedded or recorded on magnetic strips, in microchips, or in other ways compatible with the purposes described herein.

Voucher, coupon, ticket, and other issuing devices can include any devices suitable for providing useable vouchers, coupons, tickets, etc. Thus they may include, for example, printers, magnetic strip encoders, or other encoding or programming devices.

Voucher, coupon, ticket, and other readers can include any devices suitable for interpreting information printed or otherwise encoded on vouchers, coupons, tickets, etc. Thus they may include, for example, scanners, magnetic strip readers, or other signal- or data-interpreting devices.

One particularly useful application of the invention is in the administration of customer loyalty programs. As is well understood by those familiar with the arts, points or other rewards may be assigned to individual customers by an operator of a place of entertainment based, for example, on the purchase of goods or services from the operator, as for example admissions tickets, gaming credits, or food or other concessions, or for participating in games or other forms of entertainment. Awards or amounts of awards may also be made based on the longevity of a customer relationship (e.g., a number of repeat visits or purchases) or in conjunction with advertising and other promotions. Points may, for example, be awarded electronically, in the form of credits in an account; or in the form of physical vouchers or electronic points in accounts maintained, for example, by or under the control of the place of entertainment; and may be exchanged, for example, for gaming or other entertainment credits, coupons, vouchers, tickets, and/or cash or cash value. Systems and apparatus according to the invention are well adapted to the processing of loyalty awards and the administration of loyalty programs. For example, using apparatus according to the invention, it is possible for a customer of a place of entertainment to redeem loyalty program points, though suitable processing, from an electronic in-house account, or by the reading or interpretation of printed or magnetic-card type vouchers; and to apply such points to further in-house credit accounts, or to deposit them, for example, in monetary accounts maintained by third parties, such as bank accounts.

The invention further provides gaming and other systems incorporating apparatus according to the invention, and software and/or other programming or other devices for instructing apparatus to perform processing according to the invention.

### BRIEF DESCRIPTION OF THE FIGURES

The invention is illustrated in the figures of the accompanying drawings, which are meant to be exemplary and not limiting, and in which like references are intended to refer to like or corresponding parts.

FIGS. 1-3 are schematic diagrams of embodiments of apparatus according to the invention.

FIG. 4 is a schematic block diagram of an embodiment of an apparatus according to the invention.

FIG. 5 is a schematic diagram of an embodiment of a network system comprising apparatus according to the invention.

FIGS. 6-9 are schematic illustrations of component installations suitable for use in implementing the invention.

### DETAILED DESCRIPTION OF PREFERRED EMBODIMENTS

Preferred embodiments of methods, systems, and apparatus according to the invention are described through reference to the Figures.

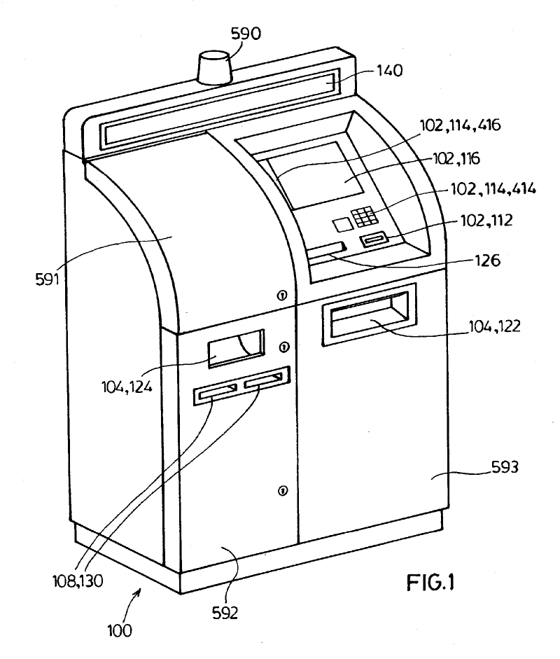

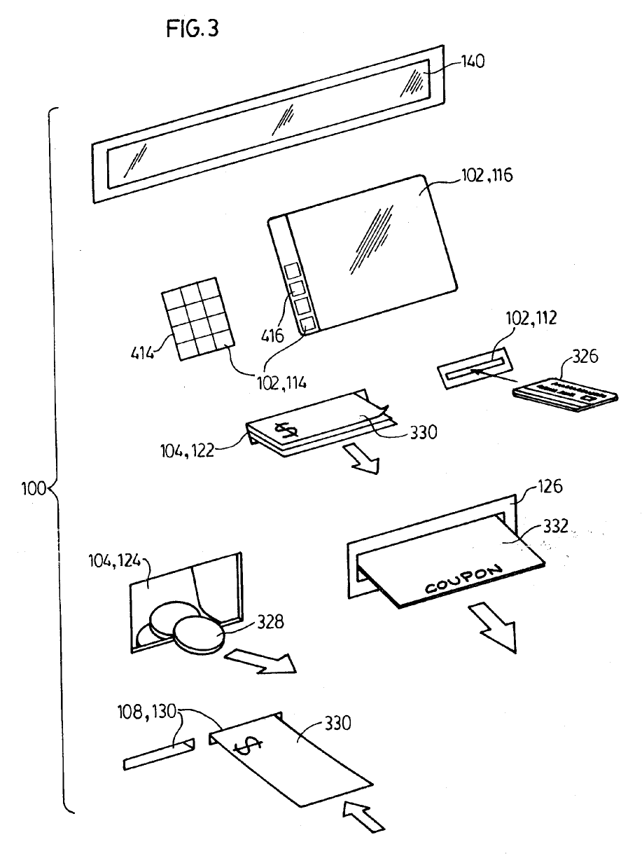

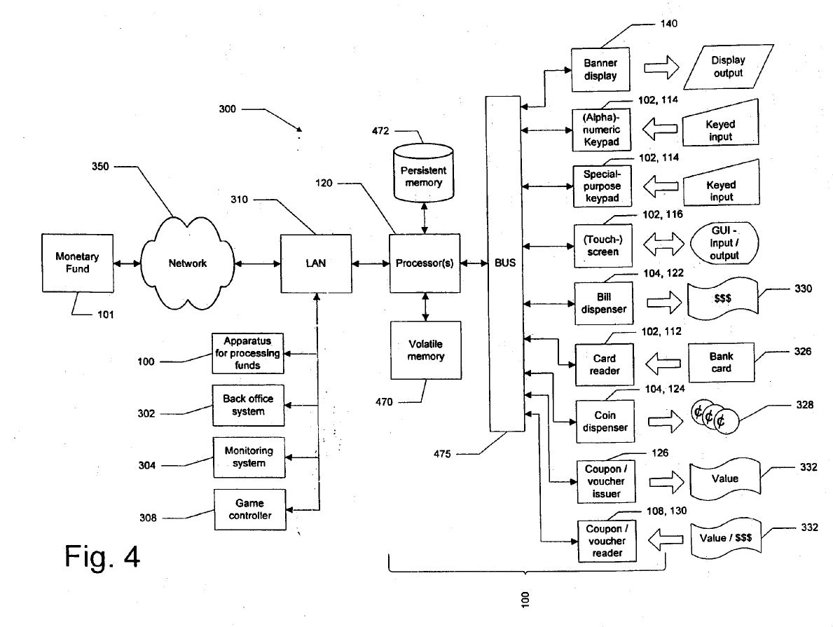

FIGS. 1-4 are schematic diagrams of embodiments of apparatus 100 according to the invention. Apparatus 100 comprises input devices 102, disbursers 104, issuing device 126, and readers 108, as well as one or more processor(s) 120 (see, e.g., FIG. 4).

Input devices 102 of FIGS. 1-4 include magnetic readers 112, which can include, for example, magnetic strip and/or card readers such as are commonly used in point-of-sale (POS) electronic funds transfer (EFT) machines and transactions; alphanumeric or special-purpose keys and/or keypads 114, and touch screen 116. Each of the input devices 102 is adapted for acquiring, inter alia, data useful in identifying and optionally accessing monetary funds maintained outside the control of the gaming or other entertainment place where the apparatus 100 is installed or operated, such as for example bank, credit, or other financial accounts maintained by financial institutions outside the control of the entertainment place; and preferably for providing signals representing such data to processor(s) 120.

For example, magnetic readers 112 can be provided for reading data encoded on electromagnetic strips on plastic or other cards 326, such as credit or debit cards like those commonly issued by banks and other financial institutions, and producing signals representing read data for further use by processor(s) in accordance with the disclosure herein. Such readers may be provided in any suitable form, including for example dip or swipe readers. Data encoded on such cards or other devices can include, for example, an account number and/or an account-holder's name or other identifiers useful in identifying and/or accessing accounts, including for example country codes and expiration dates. A wide variety of suitable card readers 112 are known and are available commercially, including for example the NCR 5000 Series card readers and the HID 3110 series insert readers, and will doubtless hereafter be developed. Dip readers such as the Dip Reader ID24 provided by Wincor-Nixdorf and used for interpreting tracks 1 and 2 of standard three-track magnetic financial card strips have been found to be particularly suitable for use in implementing the invention.

One or more alphanumeric or special-purpose keys and/or keypads 114 can also be provided for acquiring data useful in identifying monetary accounts. Keypads 114 can provide, for example, standard keys useful for producing electronic or electromagnetic signals representing the numerals 0-9 and other symbols or characters, such as special operators, and/or letters of the alphabet. Keypads 114 can also provide special-function “soft” keys adapted, for example, for convenient entering of special data or options from a provided list, such as designations of account type (e.g., checking or savings), withdrawal or deposit amounts in standard denominations (e.g., $20, $40, $100), or special instructions such as “receipt requested” or “no receipt desired.” By activating one or more keys or series of keys, a user can cause the creation of signals representing account numbers, secret access or authorization codes such as personal identification numbers (PINs), and other information for use by one or more processors in identifying and/or accessing accounts in accordance with the invention. A wide variety of keypads 114 are known and are available commercially, and will doubtless hereafter be developed.

Among the types of keypad suitable for use with the invention are special-purpose pinpads adapted for encrypting personal identification numbers (PINs) as they are entered by users. A number of such pinpads and various encryption schemes are known and employed in various sectors of the financial services industry. Examples suitable for use in implementing the invention are provided by Wincor-Nixdorf, and are adapted for use of the Triple-DES encryption standard. Additional examples are provided by NCR and Diebold.

One or more touch screens 116 can also be provided for acquiring data useful in identifying monetary accounts. Touch screen 116 can provide, for example, graphical and touch- or proximity-sensitive user interfaces for presenting input options, such as images dividing the screen into regions representing various alphabetical, numerical, or other symbols, so that a user placing a finger or other object on or in close proximity to a region representing a desired symbol causes a signal representing a portion of an account number, secret access or authorization code such as personal identification numbers (PINs), or other information to be created for use by one or more processors in identifying and/or accessing accounts in accordance with the invention. A wide variety of suitable touch screens 116, employing resistive, capacitative, and other technologies, are known and are available commercially, such as the Aspen ATM-15RM (ATM15RM) Touch-Screen, and will doubtless hereafter be developed. Wincor-Nixdorf provides a variety of suitable liquid crystal display (LCD)-based touchscreens, including a 15-inch model 01750032690 and a 12.1-inch model 01750035992, both employing analog-capacitive technology and RS 232 interfaces.

Touch screens 116, where used, can also be used as output devices for providing data to or eliciting further input from users such as individuals desiring to access monetary funds or to service the apparatus 100, in the manner of regular computer output screens presenting, for example, graphical user interfaces.

Any device or combination of devices capable of interpreting data and/or providing input signals representing data useable by a processor in identifying monetary accounts and/or establishing authority to access such accounts in accordance with the disclosure herein will serve.

Preferably one or more screens 116, printers, and/or other output devices are also provided, for eliciting information useful in or required for completing desired transactions.

Disbursers 104 shown in FIGS. 1-4 include bill dispenser 122 for dispensing paper currency 330 and coin hopper/cup/chute 124 for dispensing coins 328. Disbursers 104 are adapted for dispensing, for example, funds received electronically from a monetary fund accessed using processors and other devices according to the invention, in-house accounts, and/or exchanged for coupons, vouchers, or bank notes of various currencies.

Currency or bill dispenser 122 is adapted for dispensing paper currency 330 under the control of processor 120 using, for example, funds withdrawn or otherwise transferred from a monetary fund 101. For example, upon request of a user who has provided data identifying a monetary fund or account within or without the control of the place of entertainment in which the apparatus 100 is installed or operated, the processor 120 can access the monetary fund and provide to a processor controlling the monetary fund signals representing a request for withdrawal from the fund, and, upon receipt of signals from the processor controlling the monetary fund authorizing the withdrawal, can cause bill dispenser 122 to physically dispense a suitable amount of paper money, e.g., bank notes. Similarly, bill dispenser 122 can be used to dispense currency withdrawn from accounts held or controlled by the entertainment place, such as for example in-house gaming accounts. Any device(s) suitable for dispensing paper money in accordance with the disclosure herein will serve, including for example a wide variety of bill dispensers now available commercially and used for example in conventional ATM machines. Suitable examples include the Wincor-Nixdorf Cash Media Dispenser CMD Version 4. Other providers include Diebold.

Coin dispenser 124 is adapted for dispensing coins 328 under the control of processor 120. For example, a user wishing to break a bill or obtain change can place a bank note into one of bill validators 120, as described herein, and receive an equivalent amount of money in coin. Alternatively a user making a withdrawal from a bank account or other monetary fund 101 can designate, using for example a keypad 114 and/or touchscreen 116, that all or any portion of the withdrawal be disbursed in coin.

Alternatively, one or more coin dispensers 124 adapted for the disbursement of gaming pieces such as chips, or other tokens, may be provided. Such tokens may be disbursed, for example, in exchange for funds withdrawn from in-house or other gaming accounts, from monetary funds 101 maintained outside the control of the entertainment place, or in exchange for bank notes submitted to bill validator(s) 130.

Any device(s) suitable for dispensing coins or tokens 328 in accordance with the disclosure herein will serve, including for example a wide variety of coin dispensers now available commercially and used for example in conventional vending or change machines. For example, single or multiple Universal Hoppers HOPP-MC0001 available from Money Controls have been incorporated satisfactorily.

Issuing device (e.g., printer) 126 is adapted for printing or otherwise encoding coupons or vouchers 332 such as tickets, loyalty cards, or other evidence of value under the control of processor 120. For example, upon request of a user who has provided data identifying a monetary fund or account within or without the control of the place of entertainment in which the apparatus 100 is installed or operated, or has otherwise provided suitable amounts of credits or funds, as for example by feeding bank notes to bill validator(s) 130, the processor 120 can cause issuing device 126 to print or otherwise encode a paper coupon or voucher. In the case of coupons or vouchers 332 embodied in electronic devices such as cards, issuing device 126 can for example encode a magnetic strip or write data to an embedded microchip within a smart card.

Any issuing device(s) 126 suitable for issuing coupons or vouchers in accordance with the disclosure herein will serve, including for example a wide variety of printers and electronic or magnetic readers and encoders now available commercially and used in other applications. Such encoders may be used, for example, to print or otherwise encode cards or other devices with data identifying an individual to whom the coupon or voucher is being issued, an in-house or other account or monetary fund or other source of funds or credits, and/or a value indicating, for example, an amount of funds available within such a gaming or customer loyalty account. Optionally other data, including for example an authorized purpose for the expenditure of the funds (e.g., a given value useful for obtaining meals, lodging, or other more-or-less specific services, or for use in one or more games or other entertainment activities), may be encoded. Preferably, in the case of electronically or magnetically encoded cards or devices, the data on such cards may be modified, as for example by erasing and re-coding data such as data indicating fund amounts, so that as voucher amounts are depleted by gaming, etc., a correct balance may be reflected by the data.

In the case of printers used to encode paper or other coupons or vouchers, thermal, dot-matrix, laser, or other receipt printers of types commonly used in ATMs and cash registers will serve. An example is the TSP 1000 thermal receipt printer available from Star Micronics.

In the case of magnetic strip encoders, any devices capable of encoding magnetic strips with information sufficient for accomplishing the purposes described herein will serve. Examples include the DSP56F80x family of strip encoders available through Freescale Semiconductor and the Model MT-80, RS-232 Magnetic Stripe Encoder available through MagTek. Preferably such encoders are capable of modifying data previously encoded on coupons or vouchers, as for example by erasing and re-coding or otherwise over-writing data such as data indicating fund amounts, so that as voucher amounts are depleted by gaming, etc., a correct balance may be reflected by the data. A particularly useful reader/encoder suitable for use in implementing issuing devices according to the invention, particularly where, for example, customer loyalty programs are to be implemented, is the IGT Advantage(™) coinless casino system.

In the case of smart cards or other micro-chip carrying devices, any suitable combinations of hardware and software suitable for encoding the chip(s) will serve. For example, direct read/write devices operating according to ISO 7816 and/or proximity devices operating according to ISO 14443 or 15693 are available and suitable for implementation as components of an apparatus 100. Suitable products are available commercially from a number of sources, including for example AMAG Technology, Phillips, HID, Texas Instruments, and CardWerk.

Coupon and/or voucher readers 108 can comprise any devices, such as for example scanners and/or bar code readers, suitable for accomplishing the purposes disclosed herein, including for example reading data printed or otherwise encoded on paper or other types of coupons and/or vouchers. A wide number and variety of suitable devices are available commercially. Such readers may be used, for example, to interpret data provided on coupons and/or vouchers identifying information such as individuals to whom the coupons or vouchers are issued, in-house or other accounts or monetary funds or other sources of funds or credits, and/or values indicating, for example, amounts of funds available within such accounts.

In the case of printed cards, a large number and variety of optical and other devices such as bar-code readers or other scanners can be used, as for example in combination with optical character readers or other symbol recognition software. A large number of suitable devices are available commercially through, for example, suppliers such as Symbol Technologies and Esker.

In the case of smart cards or other micro-chip carrying devices, any suitable combinations of hardware and software suitable for reading and optionally re-encoding the chip(s) will serve. For example, direct read/write devices operating according to ISO 7816 and/or proximity devices operating according to ISO 14443 or 15693 are available. Suitable products are available commercially from a number of sources, including for example AMAG Technology, Phillips, HID, Texas Instruments, and CardWerk.

In some cases readers 108 and issuing devices 126, and other components of apparatus 100, can be provided as a single component. For example, in the case of re-writable electronically- or magnetically-programmed or -encoded cards or devices, single devices may be used to both read and encode cards, and to modify data stored on such cards, as for example by erasing and re-coding or over-writing data such as data indicating fund amounts, so that as voucher amounts are depleted by gaming, etc., a correct balance may be reflected by the data.

Apparatus 100 of FIGS. 1-3 can include a plurality of bill validators 104, 130 for accepting and validating paper currency. Currency accepted and validated by validators 130 may be processed in a variety of ways, including for example deposit into an externally-administered account 101; exchange for one or more vouchers, coupons, tickets, or other evidence of value provided for example by issuing device 126; deposit to a house account; exchange for currency or electronic funds in a foreign currency (i.e., a currency different than that of the accepted bill(s)); and for change-making. A large number and variety of suitable validators 130 are available commercially. These include, for example, the WBA-SS systems produced by JCM.

Validators 130 according to the invention may also be used as or in conjunction with readers 108 for interpreting information printed or otherwise encoded on vouchers, coupons, tickets, and other evidence of value, using, for example, suitable optical recognition software and devices.

The various components 102, 104, 108, 126, etc. can be communicatively linked to and controlled by processor(s) 120 by, for example, using suitable bus or other circuit architectures, as shown in FIG. 4. Control over the various functions performed by the components described herein may be performed solely by processor(s) 120 or partly by processor(s) 120 and partly by one or more processors associated with the various components themselves, and/or by other processors communicatively linked to processor(s) 120 via a local area network (LAN) 310, a wide area network (WAN), or other network 350 such as the Internet or a private electronic communications network (ECN), in for example a shared or distributed processing architecture.

Any special- or general-purpose computers or other data processors 120 suitable for implementing the processes and controlling the various devices and components described herein in accordance with the invention will serve. For example, Intel or other processors such as those used in desktop or other computers, or more specialized devices used in ATM and POS machines, will serve. Particularly satisfactory results have been achieved using BEETLE/M and Embedded PC (POS) systems available from Wincor-Nixdorf, adapted to control the components and perform the functions described herein. Wincor-Nixdorf BEETLE and Embedded PC systems comprise Intel Celeron and/or Pentium processors with suitable control system software and peripheral devices.

As will be appreciated by those skilled in the relevant arts, any one or more of the various components 102, 104, 108, 126 can and frequently do comprise shared or dedicated processors for controlling local operations. Alternatively, some or all control over such local operations may be performed by or shared with processor(s) 120.

As shown in FIG. 4, processor(s) 120 can comprise or otherwise be associated with volatile and/or persistent memories 470, 472, for use, in conjunction with suitable operating system software, in controlling the operation of the various components of apparatus 100 and, where appropriate, coordinating the operations of apparatus 100 with other components, e.g. additional apparatus 100 and/or back office system 302, monitoring system 304, and game or other entertainment controller 308 of a funds-controlling system 300. Processor(s) 120 are communicatively linked to input devices 102, disbursers 104, reader(s) 108, and issuer(s) 126 via bus 475, which may include, for example, a universal serial bus (USB) or any other suitable data signal communications device(s). Processor(s) 120 are further communicatively linked to other components of system 300 via LAN controller 310, and with further processors and systems, and via network 350 with systems 101 controlling monetary funds maintained outside the control of the gaming place operating system 300 and LAN 310.

As will be understood by those of ordinary skill in the relevant arts, some or all of the individual components described as portions of apparatus 100 now exist in known and understood form; and doubtless additional suitable components will be developed in the future. Those skilled in the art will not have trouble identifying or linking the various components, once they have been made familiar with this disclosure. As will also be appreciated by those of ordinary skill in the art, one or more of the various components of apparatus 100 can be provided in combined form. For example, card reader 112 can be combined with a coupon or voucher issuing device 126; and bill validators and dispensers can be combined.

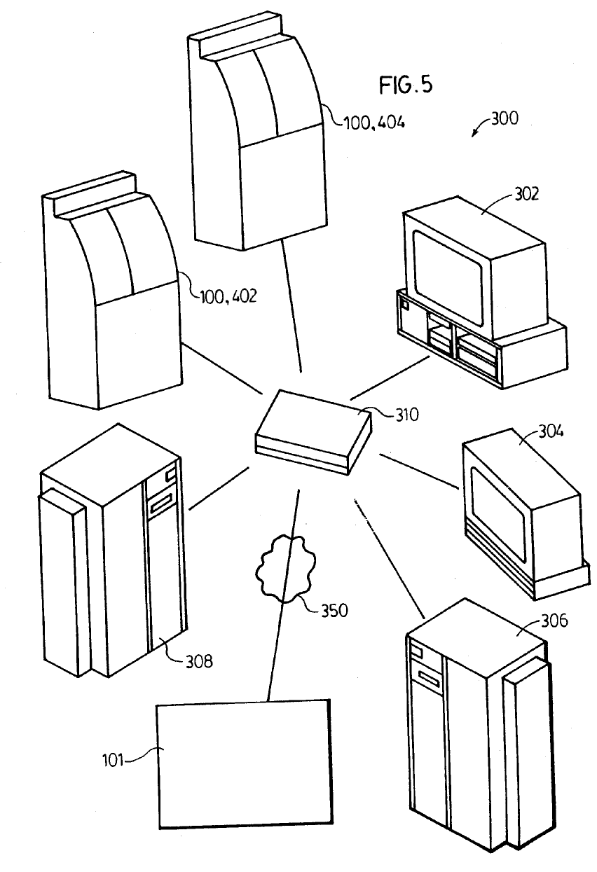

FIG. 5 is a schematic diagram of a system for controlling funds according to the invention. System 300 of FIG. 5 comprises two variants 402, 404 of apparatus 100, as well as back office system 302, monitoring system 304, patron data base system 306, and entertainment management system 308.

Variants 402, 404 of apparatus 100 provide more or less specially-adapted versions of apparatus 100. Variant 402, sometimes called a patron system, is adapted for use by patrons of a gaming casino or other place of entertainment, and comprises components and software adapted for maximizing the efficiency of manipulating monetary funds 101 and obtaining or otherwise processing gaming or entertainment funds as described herein. Variant 402 therefore emphasizes customer-friendly features such as ticket/voucher redemption, coupon processing, bill breaking and change making, currency conversion (foreign exchange), loyalty points redemption, and smart card and EFT/ATM processing, and can incorporate one or move of the various components 102, 140, 108, 126 as appropriate.

Variant 404, sometimes called an attendant system, is adapted for use by operators of gaming or other entertainment places, and comprises components and software adapted for maximizing the efficiency of operations conducted by such operators. Variant 404 can therefore emphasize features such as quick and efficient jackpot dispensing, wallet or float fill processes, and bill breaking, to ensure that patrons of the entertainment place are subjected to minimal disruption in actively playing or enjoying other entertainment; and can incorporate one or move of the various components 102, 140, 108, 126 as appropriate. An example of an advantageous application of an attendant system is in an environment in which winnings are not paid directly to patrons of a gaming place by a gaming machine in form such as a voucher, but are recorded by a human attendant, verified, and paid out to the winning patron by the human attendant using the attendant system variant 404.

Back office system 302 is adapted to provide accounting and other system maintenance and administrative functions. Monitoring system 304 provides, for example, for the monitoring of activity in apparatus 100, 402, 404 and in gaming control systems 308, for security and other purposes. System 302 can also maintain and/or administer in-house gaming, customer loyalty, and other accounts associated with patrons of the gaming place. Data base 306 provides ample and secure storage for data processed, administered, and/or controlled by the system 300 and its various components.

Entertainment management system 308 controls functions for electronic gaming and other entertainment devices, such as for example slot machines, video games, electronic card and other games of chance or skill, and lotteries.

Using system 300, for example, a patron of a gaming place can use a system 100, 402 to access funds in a monetary fund such as an externally-controlled bank or credit account, convert the funds to an in-house gaming account administered and/or maintained by system 302, and participate in gaming or other entertainment controlled by management system(s) 308 and other components of the system 300.

The various components 100, 302, 304, 306, 308 of system 300 are communicatively linked by LAN 310 to external resources including externally-maintained monetary funds 101, which may comprise, for example, bank, credit, and/or other accounts maintained by financial institutions on behalf of individuals and business entities. System 300 may comprise any numbers of the various components 100, 302, 304, 306, 308, in order to accomplish any desired objects suitable with the purposes described herein.

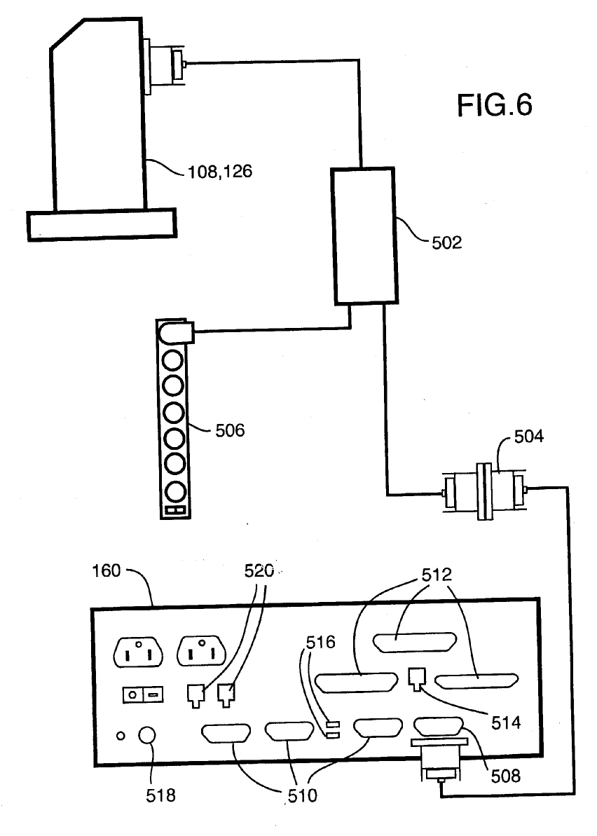

FIG. 6 is a schematic illustration of an exemplary installation of a reader 108, namely a bill validator 126, in an apparatus 100 according to the invention. Reader 108 is installed by means of a power supply/serial interface 502 and serial cable 504 to a COM 508 port of a BEETLE/M POS system 160 comprising at least one processor 120, USB 475, and memories 470, 472. Power is provided by a power bar 506. Suitable power supplies and serial interfaces are available from a number of sources, including for example Hammond Industrial. POS system 160 comprises other features, including parallel COM ports 510, serial ports 512, LAN port 514, USB ports 516, keyboard port 518, and telecommunications network ports 520.

For the sake of reliable operations and security, power supply 506 preferably comprises an uninterruptible power supply such as those provided by MGE, for use in maintaining a reliable power supply to apparatus 100 and any or all of its components 102, 104, 108, 126. Other examples of suitable power supplies include the PowerWare Model 5115 and the APC Back-UPS Model ES 725.

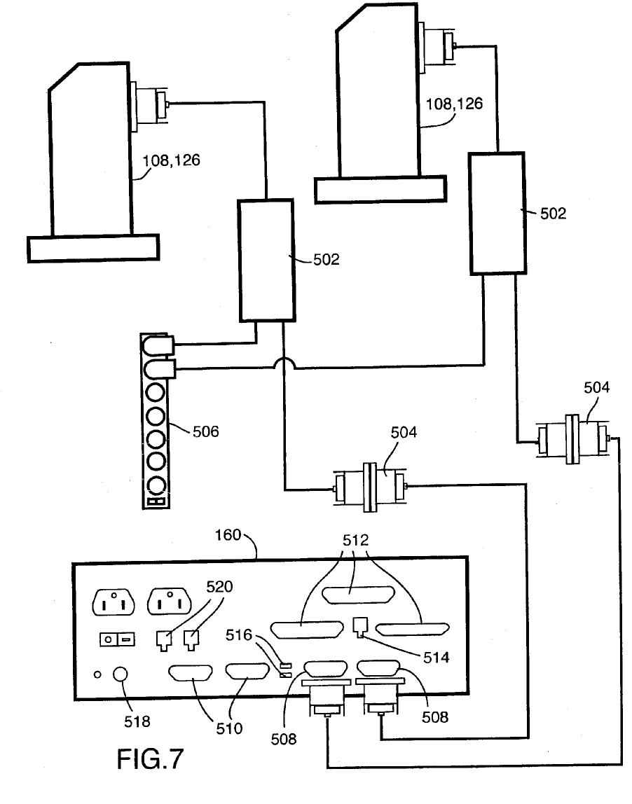

FIG. 7 is a schematic illustration of an exemplary installation of a plurality of readers 108/validators 126 in an apparatus 100 according to the invention. Communicative linking to processor 120 of POS system 160 is similar to that of FIG. 6. Advantages offered by the use of multiple and preferably redundant readers 108 include increased reliability: bill validators are currently among the most malfunction-prone of components used in apparatus according to the invention. The use of multiple readers/validators 108, 126 also facilitates the use of apparatus 100 in foreign exchange functions and in bill-breaking or change-making.

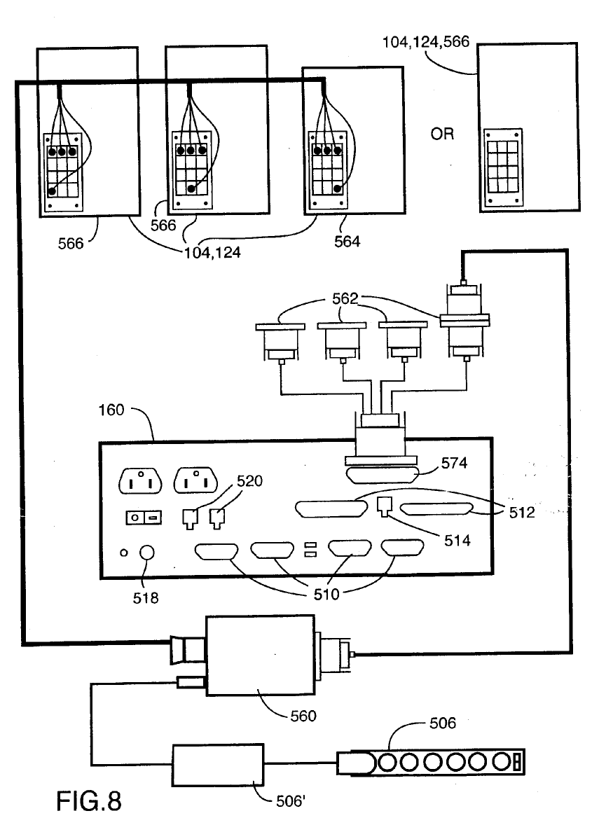

FIG. 8 is a schematic illustration of an exemplary installation of single or multiple disbursers 104, namely coin hoppers 124 in an apparatus 100 according to the invention. Advantages offered by the use of multiple coin dispensers include redundancy and improved reliability, as well as increased variety and flexibility in the number and types of coins or tokens dispensed. Coin hoppers 124 are installed by means of a power supply/parallel interface 560, 506, 506′ which comprises a CCTalk Box 560 provided by Money Controls, Inc., and comprise processors and/or other means for discriminating between varieties of coins and/or tokens. Coin hoppers 124 are connected to serial port 574 of BEETLE/M POS system 160. In a preferred embodiment, disburser 104 comprises two or more large coin hoppers 566, such as HOPP-MC0001s available from Money Controls, and one or more smaller coin hoppers 564 such as HOPP-MC0002s available from Money Controls. Optionally single hoppers 566, 564, may be provided.

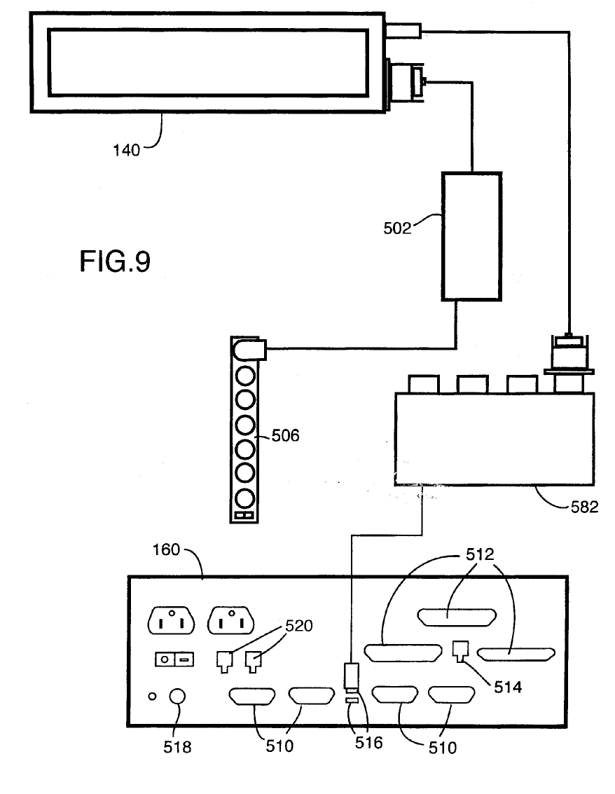

FIG. 9 is a schematic illustration of an exemplary installation of a banner display 140 comprising, for example, a LED or other display suitable for use in an apparatus 100 according to the invention. LED, marquee, or other displays 140 are useful in providing display outputs such as advertising, promotional, instructive, news, and other information for users and viewers of apparatus 100. In the embodiment shown in FIG. 9, display 140 is provided as a Beta Brite Display assembly, provided by Adaptive Micro Systems LLC, and is installed by means of a power supply/USB interface 506, 516 which comprises a display controller 582 such as an Edgeport/4 controller provided by Adaptive.

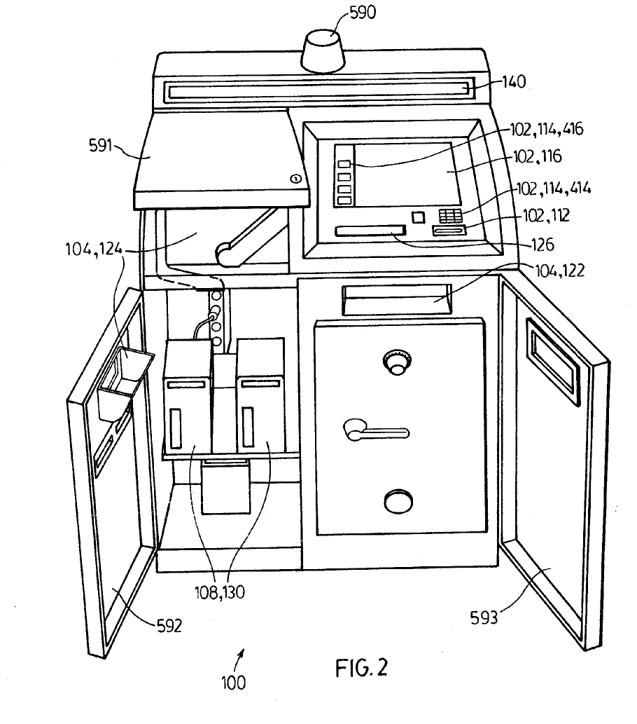

In some circumstances, particularly, for example, where an apparatus 100 is installed in a location accessible to the public, as it is contemplated such apparatus often will be, it is advantageous to provide apparatus 100 with a device 590 such as a candle or other light, or any other type of alarm operated by a circuit such that it is illuminated at any time at which any door or access panel, such as any or all of doors or covers 591, 592, 593 shown in FIGS. 1 and 2, are open or unlocked. The provision of such devices 590 can provide, for example, for improved security for the machines and for any money, coupons, vouchers, or other valuables stored in or otherwise accessible from the apparatus 100, including circuits or other devices which can be used to access funds in accounts 101. Devices 590 can advantageously be provided locally, at the apparatus 100 as shown in FIGS. 1 and 2, and/or in any other advantageous location, such as at a security desk or a control console for a system 300.

Apparatus 100 and system 300 can be operated to provide a large number and wide variety of functions useful in accommodating enjoyment of entertainment facilities and activities by patrons of entertainment facilities. For example, one useful function enabled by apparatus 100 is the accessing of a bank or credit account, or other monetary fund, by a patron of an entertainment place in order to withdraw funds for use in gaming or for other entertainment purposes.

In order to access a monetary fund and withdraw funds using an apparatus according to the invention, a user such as a patron of the entertainment place uses an input device to provide the apparatus with data useable by the processor in identifying the monetary fund. For example, the patron can provide an identification number such as an account identification number and/or other identification numbers, such as a personal identification number (PIN), using a key pad, touch screen, or card-reading device. For example, a user of an apparatus 100 shown in FIGS. 1-3 can insert a bank card bearing an encoded magnetic strip into card reader 112. Card reader 112 can read data representing fund identifiers such as account identification numbers from the card and provide signals representing the data to the processor(s) 120. Processor 120 can send to the controller of screen 116 signals causing the screen to present a request for the user to enter a PIN. The user can enter the pin using keypad 416. Activating one of the keys on keypad 416 by pushing causes a switch associated with the key to send to processor 120 a signal representing a designated data input. By activating a desired number and/or combination of keys on keypad 416, the user can provide to processor 120 data representing the PIN, and optionally other information.

Processor(s) 120 can then send to screen 116 signals causing the screen to present to the user a request for information indicating what action the user wishes to take with respect to the identified account 101. For example, the processor(s) can cause the screen to present a number of options, including a withdrawal or deposit of funds, balance inquiries, etc. For example, processor(s) 120 associated with the apparatus shown in FIGS. 1-3 can cause screen 116 to display such requests in association with one or more soft or special purpose keys of keypad 416. In response to the request presented on screen 116, the user select one or more of the keys on keypad 416, causing the keypad to send to processor(s) 120 signals representing a request for a specific action, such as a withdrawal, deposit, or balance inquiry.

Signals and data can be produced, read, written, and processed by the various components of apparatus 100, including for example input devices 102 and processor(s) 120, in any format suitable for accomplishing the purposes described herein. For example, a number of widely-accepted protocols exist for Electronic Funds Transfer, and may be used satisfactorily in implementing the invention, particularly with respect to communications between the various components of apparatus 100 and external components such as LAN server 310, other apparatus 100, 302, 304, 308, and processor(s) administering monetary funds 101 and other devices available over network 350. In many instances, ETF protocols are set or determined by banks or bank consortiums, or by other operators of ETF networks.

Having acquired data identifying a monetary fund and optionally data authorizing access to the fund and representing requests for specific actions with respect to the fund, processor 120 can access the monetary fund by sending to one or more servers or other processors administering a monetary fund 101, for example by writing appropriate data to LAN server 310 for forwarding to the servers/processors over network 350, signals representing data representing the acquired data and requesting the processor(s) to authorize access to the fund or to take specified actions with respect to the fund.

Upon receipt from the servers/processors administering monetary fund 101 of signals authorizing access to the fund 101, and optionally representing data provided in fulfillment of any action requests, such as data representing electronic funds transfers, processor(s) 120 can take further appropriate action. For example, processor(s) 120 can cause information such as account balances provided in response to requests at screen 116, can request further information desired by the servers/processors administering the monetary fund 101, or can cause withdrawn or accessed funds to be deposited to an in-house entertainment fund administered by processor(s) 120 and/or by one or more of apparatus 302, 304, and 308 and maintained in persistent memory 472 and/or one or more other databases associated with system 300. Processor(s) 120 can also, for example, upon receipt from servers/processors administering fund 101 of signals representing suitable authorizations, cause one or more of disbursers 104 and/or issuer(s) 126 to disburse instruments or other evidence of value, such as bank notes, coins, tokens coupons, and/or vouchers in amounts requested or otherwise designated by the user.

Bank notes, coins, vouchers, coupons, or other evidence of value may be issued and/or disbursed by apparatus 100 in any suitable combinations, preferably as designated or requested by the patron or other user of the apparatus 100. For example, a user wishing to withdraw funds from a bank account for use both in gaming and in making incidental expenditures inside a gaming place can use apparatus 100 to access his account and request a withdrawal of a certain amount, such as $200. Using one or more of input devices 102, the user can designate a request that a portion of the amount, for example $100, of the withdrawal be provided in cash, and the remainder, e.g., $100, in the form of coupons and/or vouchers, such as a gaming vouchers, movie or theater tickets, tokens, or other evidence of value.

Another useful activity enabled by apparatus 100 and system 300 is the deposit to a monetary fund 101 maintained outside the control of the gaming or other entertainment place by which the apparatus 100 and/or system 300 is operated or maintained of funds or value won or otherwise obtained in the entertainment place. For example, a patron of a gaming place who has won a game can be given a voucher or other evidence of value, which the patron can insert into a reader 108. The reader 108 can for example scan the voucher or other evidence, verify its authenticity and value, retain the voucher and store it securely within the apparatus 100, and provide to processor(s) 120 signals representing the authenticated value. Processor(s) 120 can then provide signals to the controller of screen 116 causing screen 116 to present information confirming the value and/or requesting that the patron or other user identify himself and an account to which he wishes the value to be deposited, or another action the patron wishes to take with the value. Using processes such as those described herein, the patron can use one or more of input devices 102 to provide to the processor(s) 120 information comprising suitable identifiers and/or authorizations, and processor(s) 120 can control the electronic transfer to and deposit within the monetary fund 101 of funds representing the value represented by the voucher.

Winnings or other value acquired by patrons of the entertainment place can also be input to and processed by apparatus 100 and system 300 and returned to a patron or other user in other forms, such as cash disbursed by disbursers 104 or other vouchers or coupons provided by an issuing device 126 For example, cash winnings or prizes can be input to one or more readers such as bill validators 130 by a patron; validated; and, by means of signals generated by the bill validator and provided to the processor(s) 120, together with suitable identifying information provided via input device(s) 102, the value of the deposited bills can be deposited electronically to a monetary fund 101.

Apparatus 100 and system 300 can further be employed to accomplish other functions. For example, as described herein apparatus 100 can be used for foreign exchange by employing processor(s) 120, input devices 102, and one or more bill readers 130 and disbursers 104 to control and accomplish the acceptance of notes or coins in a first currency and disburse notes or coins in a second currency. For example, a patron wishing to convert $100 US to Canadian dollars can input one or more US bank notes to a reader/validator 130, which can validate the authenticity of the bills and provide to processor(s) 120 signals indicating the confirmed values of the bill, and in response to signals received from input devices 102 in response to suitable requests presented to the patron at screen 116, and cause an equivalent number of bank notes and/or coins to be disbursed from disbursers 104, 124, 122 in Canadian currency.

Apparatus 100 can also be used to accomplish foreign exchange by accessing a monetary fund 101 maintained in a first currency and disbursing bank notes and/or coins in a second currency; and for change-making or bill-breaking by accepting notes of one denomination and disbursing notes of equivalent value in smaller denominations, or vice versa.

It will be understood that apparatus and systems described herein may be controlled or otherwise operated using computer software or other programming media. Such software or other programming may be provided and or developed in any suitable language and/or form, and is a part of the invention disclosed herein.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above, as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

What is claimed is:

1. Apparatus for processing funds for use in a gaming or other entertainment place, comprising:
at least one input device for acquiring data useful in identifying a monetary fund maintained outside the control of the entertainment place;
at least one processor adapted for controlling a request for an electronic transfer of funds from the monetary fund and for controlling reception of an electronic transfer of funds from the monetary fund;
at least one disburser for disbursing funds received electronically from the monetary fund; and
at least one of: a voucher issuing device; a coupon issuing device; a reader for interpreting information encoded on a voucher; and a reader for interpreting information encoded on a coupon.

2. The apparatus of claim 1, wherein the at least one disburser is adapted for dispensing currency.

3. The apparatus of claim 2, wherein the at least one disburser comprises at least one of a bill dispenser and a coin dispenser.

4. The apparatus of claim 1, wherein the at least one disburser is adapted for electronically dispensing funds received electronically from the monetary fund to a gaming account maintained within the control of the entertainment place.

5. The apparatus of claim 1, comprising at least one voucher issuing device, wherein the disburser and voucher issuing device are adapted for disbursing funds received electronically from the monetary fund in the form of a voucher.

6. The apparatus of claim 1, comprising at least one coupon issuing device, wherein the disburser and coupon issuing device are adapted for disbursing funds received electronically from the monetary fund in the form of a coupon.

7. The apparatus of claim 6, wherein the coupon comprises a ticket.

8. The apparatus of claim 1, wherein the at least one input device comprises a reader for interpreting information encoded on an account-identifying device.

9. The apparatus of claim 1, wherein the at least one input device comprises one or more keys.

10. The apparatus of claim 1, wherein the input device comprises a touch screen interface.

11. The apparatus of claim 1, wherein the voucher issuing device comprises a printer for printing a paper voucher.

12. The apparatus of claim 1, wherein the voucher issuing device comprises a device for encoding an electronic voucher card.

13. The apparatus of claim 1, wherein the coupon issuing device comprises a printer for printing a paper coupon.

14. The apparatus of claim 13, wherein the coupon comprises a ticket.

15. The apparatus of claim 1, wherein the coupon issuing device comprises a device for encoding an electronic coupon card.

16. The apparatus of claim 1, comprising at least two disbursers.

17. The apparatus of claim 16, wherein the at least two disbursers are adapted for disbursing money of at least two currencies.

18. The apparatus of claim 1, wherein the at least one disburser is adapted for disbursing money in a currency other than a currency in which the monetary fund is maintained.

19. Apparatus for processing funds for use in a gaming or other entertainment place, comprising:
at least one input device for acquiring data useful in identifying a monetary fund maintained outside the control of the entertainment place;
at least one processor adapted for controlling a request for an electronic transfer of funds from the monetary fund, for controlling reception of an electronic transfer of funds from the monetary fund, and for controlling electronic disbursement of funds electronically received from the monetary fund to a gaming account maintained within the control of the entertainment place.

20. Apparatus for processing gaming funds, comprising:
at least one reader for electronically interpreting information encoded on a gaming voucher, the encoded information representing a residual monetary amount from gaming in an entertainment place;
at least one input device for acquiring data useful in identifying a monetary fund maintained outside the control of the entertainment place;
at least one processor adapted for controlling a request for an electronic transfer of funds to the monetary fund for deposit, the transfer comprising funds represented by the encoded information.

21. The apparatus of claim 20, wherein the reader comprises an optical scanner.

22. The apparatus of claim 20, wherein the reader comprises a device for interpreting electromagnetically-encoded information.

23. Apparatus for processing gaming funds, comprising:
a processor for controlling receipt from a gaming computer system of data representing a residual monetary amount from gaming conducted using the gaming computer system;
at least one input device for acquiring data useful in identifying a monetary fund maintained outside the control of the gaming place;
the same or another processor adapted for controlling a request for an electronic transfer of funds to the monetary fund for deposit, the transfer comprising funds represented by the data representing a residual monetary amount.
